(19) United States
(12) Patent Application Publication
(10) Pub. No.: US 2026/0061684 A1
(43) Pub. Date: Mar. 5, 2026

(54) INJECTION MOLDING MACHINE AND METHOD OF ESTIMATING AMOUNT OF DEPOSITION OF MOLD DEPOSIT

(71) Applicant: SUMITOMO HEAVY INDUSTRIES, LTD., Tokyo (JP)

(72) Inventors: Tatsuya MURAI, Chiba-shi (JP); Ryuichi TOKUNOU, Chiba-shi (JP)

(21) Appl. No.: 19/238,387

(22) Filed: Jun. 14, 2025

(30) Foreign Application Priority Data
Aug. 28, 2024 (JP) 2024-146750

(51) Int. Cl. B29C 45/76; B29C 45/17

(52) U.S. Cl. CPC B29C 45/7626; B29C 2045/1785; B29C 2945/76244; B29C 2945/76394; B29C 2945/76939; B29C 2945/76993

(57) ABSTRACT

An injection molding machine includes: an acquisition unit configured to acquire, during a mold opening operation of a mold, at least one of a first measurement value relating to a resistance when a protrusion operation of an ejector pin to release a molding product from the mold in a mold-opened state is performed and a second measurement value relating to a resistance when an accommodation operation of the ejector pin is performed; and an estimation unit configured to estimate an amount of deposition of a mold deposit deposited on the mold, based on at least one of the first measurement value, excluding an element before the molding product is released or lowering a priority of the element, and the second measurement value.

### CROSS-REFERENCE TO RELATED APPLICATIONS

This application claims priority to Japanese Patent Application No. 2024-146750, filed on Aug. 28, 2024, which is incorporated by reference herein in its entirety.

### BACKGROUND

### Technical Field

A certain embodiment of the present invention relates to an injection molding machine and a method of estimating an amount of deposition of a mold deposit.

### Description of Related Art

A technique is known for determining whether or not there is an abnormality during the drive of an ejector mechanism that releases a molding product from a mold of an injection molding machine (for example, the related art). In such a technique, it is determined whether or not “galling” of an ejector pin has occurred from the current value detected when the ejector mechanism is driven. The “galling” is a significant scratch generated on a surface of the molding product, and is caused by abnormal friction, or the like.

### SUMMARY

According to an embodiment of the present invention, there is provided an injection molding machine including: an acquisition unit configured to acquire, during a mold opening operation of a mold, at least one of a first measurement value relating to a resistance when a protrusion operation of an ejector pin to release a molding product from the mold in a mold-opened state is performed and a second measurement value relating to a resistance when an accommodation operation of the ejector pin is performed; and an estimation unit configured to estimate an amount of deposition of a mold deposit deposited on the mold, based on at least one of the first measurement value, excluding an element before the molding product is released or lowering a priority of the element, and the second measurement value.

In addition, according to an embodiment of the present invention, there is provided a method of estimating an amount of deposition of a mold deposit, the method including: a step of acquiring, during a mold opening operation of a mold, at least one of a first measurement value relating to a resistance when a protrusion operation of an ejector pin to release a molding product from the mold in a mold-opened state is performed and a second measurement value relating to a resistance when an accommodation operation of the ejector pin is performed; and a step of estimating an amount of deposition of a mold deposit deposited on the mold, based on at least one of the first measurement value, excluding an element before the molding product is released or lowering a priority of the element, and the second measurement value.

### BRIEF DESCRIPTION OF THE DRAWINGS

FIGS. 1A to 1D are views illustrating an example of an operation of an ejector pin of an ejector mechanism included in an injection molding machine according to the present embodiment.

FIG. 2 is a diagram illustrating an example of a hardware configuration of the injection molding machine.

FIG. 3 is a diagram illustrating an example of a functional configuration of a control unit of FIG. 2.

FIG. 4 is a diagram illustrating a specific example of a graph representing a time change of an ejector torque.

FIG. 5 is a diagram illustrating a specific example of a graph representing a time change of an ejector torque.

FIG. 6 is a diagram illustrating a specific example of information displayed on a display of a display unit of FIG. 2.

FIG. 7 is a diagram illustrating a specific example of a graph representing a relationship between the number of shots and an ejector torque.

### DETAILED DESCRIPTION

In the related art, a resistance generated when the molding product is released from the mold cannot be completely excluded from the detected current value. Therefore, the amount of deposition of the mold deposit deposited on the mold cannot be accurately estimated as the number of drives of the ejector mechanism increases. In this case, there is a possibility that a maintenance timing of the mold will be missed.

It is desirable to make it possible to accurately determine a maintenance timing of a mold of an injection molding machine.

Here, the injection molding machine may include a spring mechanism that generates a force in a direction in which the accommodation operation of the ejector pin is performed, in which the estimation unit may estimate the amount of deposition by excluding the second measurement value or lowering a priority of the second measurement value in a case where the first measurement value and the second measurement value are acquired.

In addition, the injection molding machine may further include a detection unit configured to detect a maintenance timing of the mold, based on the amount of deposition that is estimated.

In addition, the estimation unit may estimate an amount of deposition of a mold deposit deposited on the mold, based on a magnitude of a frictional resistance generated between the ejector pin and the mold, the frictional resistance being obtained from the first measurement value that is acquired, by excluding, as the element and an additional element, a collision resistance generated between the ejector pin and the molding product and a noise of a motor that drives the ejector pin, or lowering a priority of the elements.

In addition, the injection molding machine may further includes: a management unit configured to store and manage the first measurement value and the second measurement value, which are acquired, in an external storage medium.

Hereinafter, an embodiment of the present invention will be described in detail with reference to the accompanying drawings.

### Operation of Ejector Pin 111

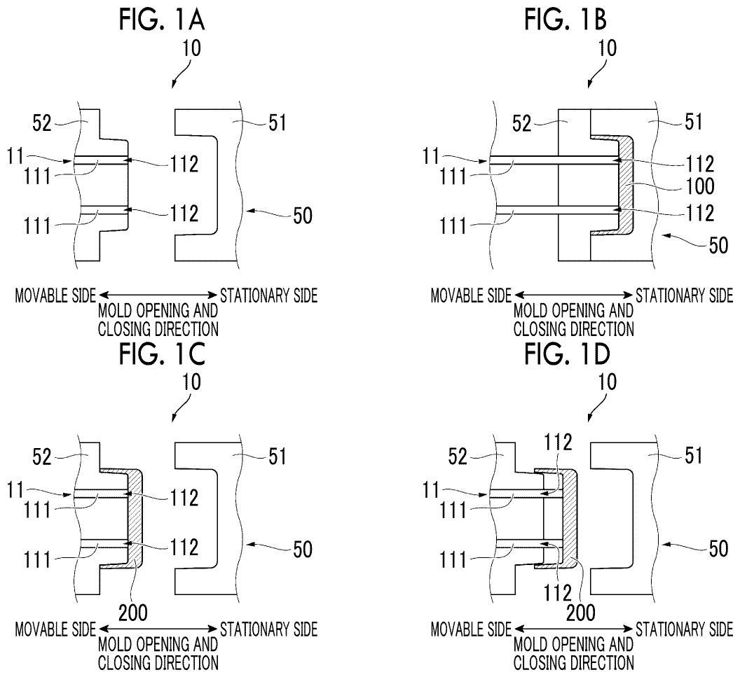

FIGS. 1A to 1D are views illustrating an example of an operation of an ejector pin 111 of an ejector mechanism 11 included in an injection molding machine according to the present embodiment.

The ejector mechanism 11 illustrated in FIGS. 1A to 1D is a mechanism that constitutes a part of a mold clamping unit 10 of an injection molding machine 1, which performs injection molding of a molding product 200 using a resin 100 as a molding material. The ejector mechanism 11 is a mechanism that releases the molding product 200 from a mold 50 in a mold-opened state during a mold opening operation of the mold clamping unit 10, which performs a mold opening and closing operation. In each of FIGS. 1A to 1D, a right side of the mold 50 in a mold opening and closing direction is set as a stationary side, and a left side is set as a movable side.

The mold 50 includes a stationary-side mold 51, which is also referred to as a cavity, and a movable-side mold 52, which is also referred to as a core. The stationary-side mold 51 is a mold in which a position in the mold opening and closing direction is fixed. On the other hand, the movable-side mold 52 is a mold of which a position in the mold opening and closing direction is not fixed and which is movable in the mold opening and closing direction in accordance with the mold opening and closing operation of the mold clamping unit 10. Specifically, the movable-side mold 52 moves to the stationary side in the mold opening and closing direction in accordance with a mold closing operation of the mold clamping unit 10 to come into contact with the stationary-side mold 51. In addition, the movable-side mold 52 moves to the movable side in the mold opening and closing direction in accordance with the mold opening operation of the mold clamping unit 10 to be separated from the stationary-side mold 51.

In FIGS. 1A to 1D, a flow of the mold opening and closing operation of the mold clamping unit 10 is illustrated in order of FIGS. 1A to 1D. FIG. 1A illustrates a state before the mold closing operation of the mold clamping unit 10 is performed. In the state illustrated in FIG. 1A, the stationary-side mold 51 and the movable-side mold 52 are separated from each other. FIG. 1B illustrates a state where the mold closing operation and a mold clamping operation are performed by the mold clamping unit 10, and the resin 100 is cooled after the resin 100 in a molten state is injected from an injection unit (not illustrated). In the state illustrated in FIG. 1B, the molding product is to be molded in a space formed by the contact between the stationary-side mold 51 and the movable-side mold 52.

FIG. 1C illustrates a state after the mold opening operation is performed by the mold clamping unit 10. In the state illustrated in FIG. 1C, the stationary-side mold 51 and the movable-side mold 52 are separated from each other. In addition, the molding product 200 (the resin 100 before solidification) is attached to the movable-side mold 52. FIG. 1D illustrates a state where the ejector mechanism 11 is driven. In the state illustrated in FIG. 1D, the ejector pin 111 of the ejector mechanism 11 protrudes toward the stationary side in the mold opening and closing direction to press the molding product 200 and release the molding product 200 from the movable-side mold 52. As a result, the molding product 200 falls freely.

In this manner, the ejector pin 111 repeats an operation of protruding a tip part to the stationary side in the mold opening and closing direction (hereinafter, referred to as a “protrusion operation”) and an operation of accommodating the protruded tip part (hereinafter, referred to as an “accommodation operation”). The protrusion operation and the accommodation operation performed by the ejector pin 111 are repeated by moving inside a through-hole 112 extending in the mold opening and closing direction and provided in the movable-side mold 52 as a part of the ejector mechanism 11. Therefore, when the number of drives of the ejector mechanism 11 increases, a residue of an additive or a lubricant contained in the molding material is deposited on the mold 50 and the like as a mold deposit.

Specifically, for example, the mold deposit is deposited at a location related to the drive of the ejector mechanism 11 such as a gap formed between the ejector pin 111 and the through-hole 112 or the vicinity of an inlet or an outlet of the through-hole 112. The mold deposit deposited at such a location is a factor that hinders the smooth drive of the ejector pin 111, and is removed during regular maintenance of the mold 50.

A timing for performing maintenance on the mold 50 is determined depending on the extent to which the mold deposit hinders the smooth drive of the ejector mechanism 11. The extent to which the mold deposit hinders the smooth drive of the ejector mechanism 11 is determined based on an amount of deposition of the mold deposit deposited at a location related to the drive of the ejector mechanism 11. The amount of deposition of the mold deposit deposited at a location related to the drive of the ejector mechanism 11 is estimated based on an actual value of a measurement value relating to a resistance of the ejector pin 111 (hereinafter, referred to as “ejector torque”). When the estimated value exceeds a predetermined level, the injection molding machine 1 detects a maintenance timing of the mold 50. That is, since the ejector pin 111 is driven by a motor (not illustrated), the torque of the motor changes according to the resistance of the ejector pin 111. Therefore, the resistance of the ejector pin 111 can be estimated by measuring the torque of the motor. As means for estimating the torque of the motor, in the present embodiment, the current value of the motor is used.

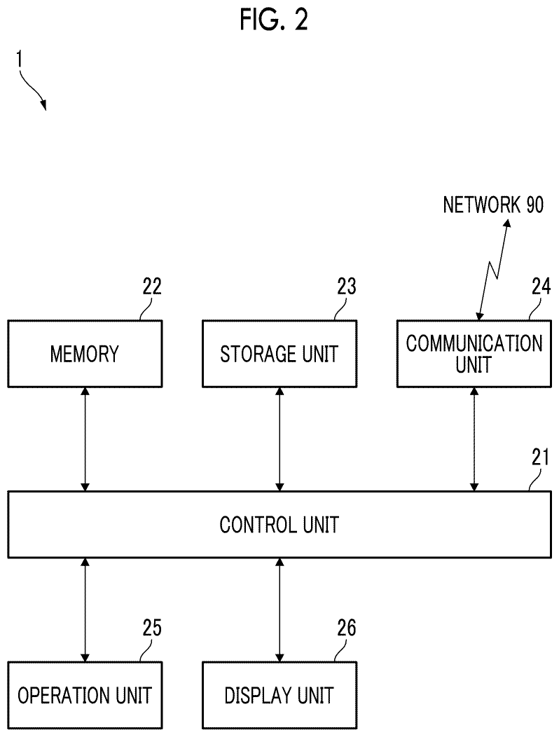

FIG. 2 is a diagram illustrating an example of a hardware configuration of the injection molding machine 1.

The injection molding machine 1 includes a control unit 21, a memory 22, a storage unit 23, a communication unit 24, an operation unit 25, and a display unit 26. Each of these parts is connected by a data bus, an address bus, a Peripheral Component Interconnect (PCI) bus, or the like.

The control unit 21 is a processor that controls the functions of the injection molding machine 1 through the execution of various software such as an operating system (OS) and application software. The control unit 21 includes, for example, a central processing unit (CPU). The memory 22 is a storage area that stores various software, data used for the execution of the software, and the like, and is used as a work area for calculation. The memory 22 includes, for example, a random-access memory (RAM), or the like.

The storage unit 23 is a storage area that stores input data for various software, output data from various software, and the like. The storage unit 23 includes, for example, a hard disk drive (HDD), a solid-state drive (SSD), a semiconductor memory, or the like used for storing a program, various setting data, or the like.

The communication unit 24 transmits and receives data between the other devices and the outside through a network 90 such as the Internet. For example, the communication unit 24 transmits and receives the actual value of the ejector torque to and from a storage server (not illustrated) existing on the network 90.

The operation unit 25 includes, for example, a keyboard, a mouse, a mechanical button, and a switch, and receives an input operation. The operation unit 25 also includes a touch sensor that is integrated with the display unit 26 to constitute a touch panel. The display unit 26 includes, for example, a liquid-crystal display or an organic electroluminescence (EL) display used for displaying information, and displays data such as an image or text. A user interface or the like is displayed on the display unit 26.

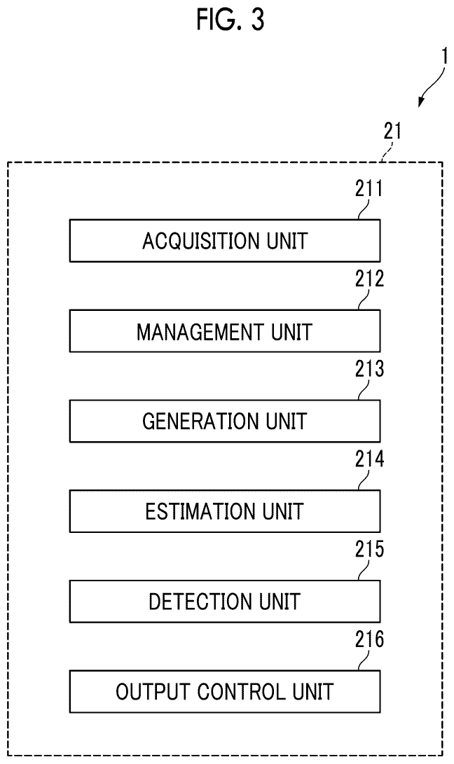

FIG. 3 is a diagram illustrating an example of a functional configuration of the control unit 21 of FIG. 2.

In the control unit 21 of the injection molding machine 1, an acquisition unit 211 that acquires various types of information functions as an acquisition unit, a management unit 212 that manages various types of information functions as a management unit, and a generation unit 213 that generates various types of information functions as a generation unit. In addition, in the control unit 21, an estimation unit 214 that estimates the amount of deposition of the mold deposit deposited on the mold 50 functions as an estimation unit, a detection unit 215 that detects the maintenance timing of the mold 50 functions as a detection unit, and an output control unit 216 that outputs various types of information functions as an output unit.

The acquisition unit 211 acquires various types of information on the mold clamping unit 10 of the injection molding machine. For example, the acquisition unit 211 acquires the ejector torque measured by the ejector mechanism 11 of the mold clamping unit 10. The ejector torque acquired by the acquisition unit 211 includes at least the ejector torque measured at the following timing. That is, the ejector torque acquired by the acquisition unit 211 includes an ejector torque as a first measurement value measured when the ejector pin 111 (refer to FIGS. 1A to 1D) performs the protrusion operation and an ejector torque as a second measurement value measured when the ejector pin 111 performs the accommodation operation. Hereinafter, in a case where it is not necessary to describe the ejector torque by distinguishing between a first measurement value and a second measurement value, the ejector torque is simply referred to as an “ejector torque”.

The management unit 212 manages various types of information required to estimate the amount of deposition of the mold deposit deposited at a location related to the drive of the ejector mechanism 11. For example, the management unit 212 stores the ejector torque acquired by the acquisition unit 211 in a storage server existing on the network 90 (refer to FIG. 2) as a past actual value, and manages the ejector torque. In addition, the management unit 212 can also store and manage the ejector torque acquired by the acquisition unit 211 in an external storage medium such as an external hard disk.

The past actual value of the ejector torque can be stored in the storage unit 23 of the injection molding machine, but there is a physical limit to the amount of data that can be stored, and thus the amount of data required for estimating the amount of deposition of the mold deposit cannot be stored in the storage unit 23 of the injection molding machine. Therefore, the management unit 212 connects the injection molding machine 1 to a network 90 such as the Internet, and stores and manages the past actual value of the ejector torque in a storage server (not illustrated) existing on the network 90.

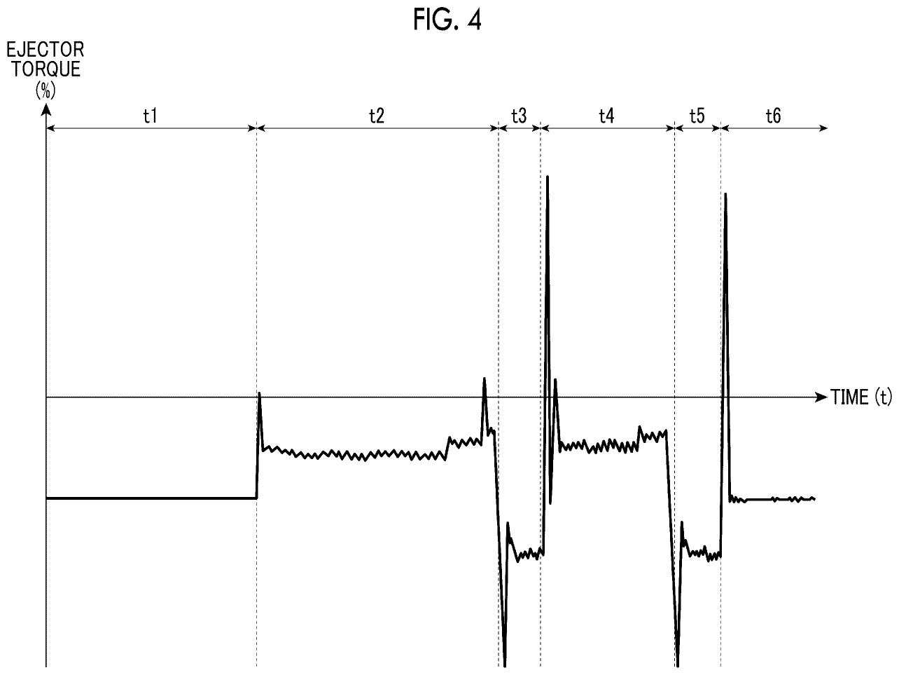

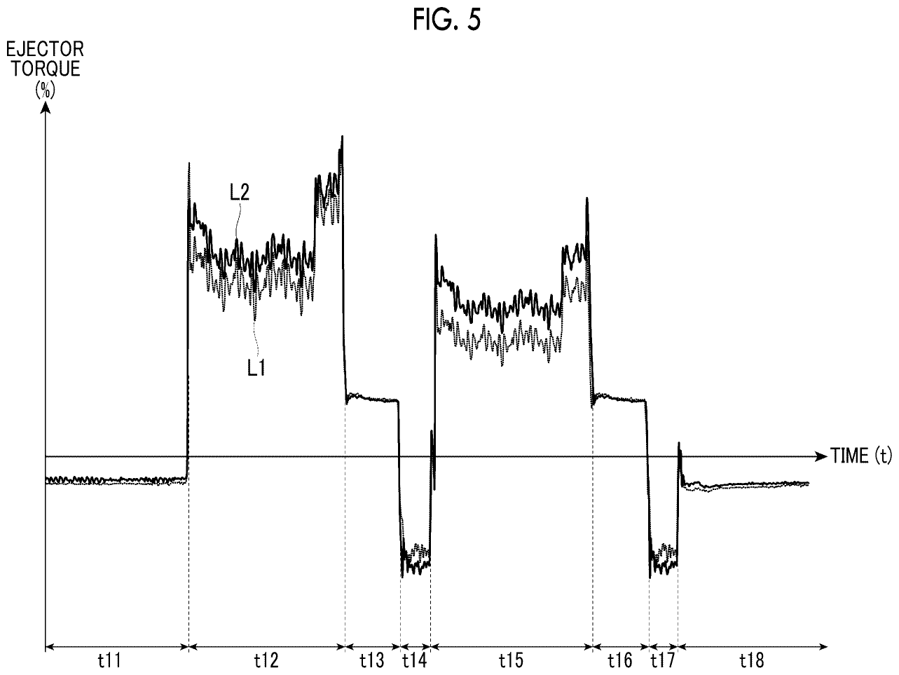

The generation unit 213 generates various types of information for estimating the amount of deposition of the mold deposit deposited at a location related to the drive of the ejector mechanism 11, based on the actual value of the ejector torque managed by the management unit 212. For example, the generation unit 213 generates a graph representing a time change of the ejector torque. From the graph representing the time change of the ejector torque, it is possible to read the ejector torque as a first measurement value measured during the protrusion operation of the ejector pin 111 and the ejector torque as a second measurement value measured during the accommodation operation of the ejector pin 111. A specific example of a graph representing a time change of the ejector torque generated by the generation unit 213 will be described later with reference to FIGS. 4 and 5.

The estimation unit 214 estimates the amount of deposition of the mold deposit deposited at a location related to the drive of the ejector mechanism 11, based on the information generated by the generation unit 213. For example, the estimation unit 214 estimates the amount of deposition of the mold deposit deposited at a location related to the drive of the ejector mechanism 11, based on the information indicating the time change of the ejector torque generated by the generation unit 213.

For example, the estimation unit 214 estimates the amount of deposition of the mold deposit deposited at a location related to the drive of the ejector mechanism 11 by the following method. That is, among the ejector torques managed by the management unit 212, the ejector torque measured when the ejector pin 111 performs the protrusion operation includes the following four elements (first to fourth elements).

The first element is a frictional resistance generated between the ejector pin 111 and an inner wall surface of the through-hole 112. One of the factors causing the frictional resistance is the presence of the mold deposit deposited at a location related to the drive of the ejector mechanism 11. Therefore, the frictional resistance generated between the ejector pin 111 and the inner wall surface of the through-hole 112 is an important element for estimating the amount of deposition of the mold deposit.

In addition, the second element is a collision resistance generated between the ejector pin 111 and the molding product 200. This collision resistance is generated regardless of the deposition of the mold deposit, and is not an element for estimating the amount of deposition of the mold deposit. Therefore, the second element is excluded in the processing of estimating the amount of deposition of the mold deposit, or is subject to calculation processing of lowering its priority.

In addition, the third element is a noise of a motor (not illustrated) that drives the ejector pin 111. This noise is generated regardless of the deposition of the mold deposit, and is not an element for estimating the amount of deposition of the mold deposit. Therefore, the third element is excluded in the processing of estimating the amount of deposition of the mold deposit, or is subject to calculation processing of lowering its priority.

In addition, the fourth element is a restoring force of a spring of a spring mechanism (not illustrated). The “spring mechanism” is a mechanism that has a spring which generates a force in a direction in which the accommodation operation of the ejector pin 111 is performed (the movable side in the mold opening and closing direction in FIGS. 1A to 1D), and assists the accommodation operation of the ejector pin 111 using a restoring force of the spring. When the ejector pin 111 performs the protrusion operation, the ejector pin 111 protrudes while the spring of the spring mechanism is contracted. Therefore, a restoring force of the spring of the spring mechanism (a force for pushing back the ejector pin 111) is generated. The restoring force is generated regardless of the deposition of the mold deposit, and is not an element for estimating the amount of deposition of the mold deposit. Therefore, the fourth element is excluded in the processing of estimating the amount of deposition of the mold deposit, or is subject to calculation processing of lowering its priority.

That is, the estimation unit 214 excludes the second to fourth elements that are generated regardless of the deposition of the mold deposit from the graph representing the time change of the ejector torque generated by the generation unit 213, or performs calculation processing of lowering their priority. The estimation unit 214 estimates the amount of deposition of the mold deposit deposited at a location related to the drive of the ejector mechanism 11, based on the first element obtained by excluding the second to fourth elements from the graph representing the time change of the ejector torque, or by calculation processing of lowering their priority. Specific examples of a method of excluding the second to fourth elements from the graph representing a time change of the ejector torque, or lowering their priority will be described later with reference to FIGS. 4 and 5.

Furthermore, the estimation unit 214 can estimate the amount of deposition of the mold deposit, based on the first element and the ejector torque measured when the accommodation operation of the ejector pin 111 is performed in the graph representing the time change of the ejector torque. The ejector torque measured during the accommodation operation of the ejector pin 111 does not include the second element described above, and thus the measurement value is used without further correction.

The detection unit 215 detects the maintenance timing of the mold 50, based on the amount of deposition of the mold deposit deposited on the mold 50 estimated by the estimation unit 214. Specifically, the detection unit 215 detects the maintenance timing of the mold 50 when the estimated value of the amount of deposition of the mold deposit deposited on the mold 50 exceeds a predetermined level.

The output control unit 216 performs control to output information for notifying of the maintenance timing of the mold 50 detected by the detection unit 215. For example, the output control unit 216 displays an alert on the display of the display unit 26 of the injection molding machine as information for notifying of the maintenance timing of the mold 50.

### Specific Example of Graph Representing Time Change of Ejector Torque

FIGS. 4 and 5 are views illustrating specific examples of graphs representing the time change of the ejector torque.

The graphs illustrated in FIGS. 4 and 5 are graphs in which a horizontal axis is time (t) and a vertical axis is the ejector torque (%). The graph illustrated in FIG. 4 represents a time change of the ejector torque when the gas is not accumulated in the mold 50, and the graph illustrated in FIG. 5 represents a time change of the ejector torque when the gas is accumulated in the mold 50. In addition, the graph illustrated in FIG. 5 illustrates the time change of the ejector torque before and after the mold deposit is deposited on the mold 50, respectively. A line L1 illustrated in FIG. 5 indicates an ejector torque before the mold deposit is deposited on the mold 50. In addition, a line L2 indicates an ejector torque after the mold deposit is deposited on the mold 50.

In the graph illustrated in FIG. 4, a time period t1 is a time period before a first protrusion operation is performed by the ejector pin 111. In the time period t1, since the ejector pin 111 is not driven, the ejector torque is substantially constant (substantially zero). A time period t2 is a time period when the first protrusion operation is performed by the ejector pin 111. In the time period t2, since the ejector pin 111 is driven to perform the protrusion operation, the ejector torque is larger than that in the time period t1.

A time period t3 is a time period when a first accommodation operation is performed by the ejector pin 111. In the time period t3, the ejector pin 111 performs the accommodation operation while receiving assistance from the restoring force of the spring of the spring mechanism. Therefore, the absolute value of the ejector torque in the time period t3 in which the restoring force of the spring assists the accommodation operation is smaller than the absolute value of the ejector torque in the time period t2 in which the restoring force of the spring is the resistance of the protrusion operation. A time period t4 is a time period when a second protrusion operation is performed by the ejector pin 111. In the time period t4, since the ejector pin 111 is driven to perform the protrusion operation, the ejector torque is larger than that in the time period t1.

In addition, a time period t5 is a time period when a second accommodation operation is performed by the ejector pin 111. In the time period t5, the ejector pin 111 performs the accommodation operation while receiving assistance from the restoring force of the spring of the spring mechanism. Therefore, the absolute value of the ejector torque in the time period t5 in which the restoring force of the spring assists the accommodation operation is smaller than the absolute value of the ejector torque in the time period t4 in which the restoring force of the spring is the resistance of the protrusion operation. A time period t6 is a time period after the second accommodation operation is performed by the ejector pin 111. In the time period t6, since the ejector pin 111 is not driven, the ejector torque returns to the level in the time period t1 and is substantially constant (substantially zero).

The graph illustrated in FIG. 4 includes the four elements (first to fourth elements) described above. However, since the second to fourth elements among the four elements are generated regardless of the deposition of the mold deposit, the second to fourth elements are excluded, or are subject to calculation processing of lowering their priority. For example, in the time period t2, since the ejector pin 111 performs the first protrusion operation, the ejector pin 111 collides with the molding product 200, and a collision resistance occurs between the ejector pin 111 and the molding product 200. Since the collision resistance is a second element that is generated regardless of the deposition of the mold deposit, the collision resistance is excluded in the processing of estimating the amount of deposition of the mold deposit, or is subject to calculation processing of lowering its priority. Therefore, for example, in the processing of estimating the amount of deposition of the mold deposit, the entire ejector torque in the time period t2 when the first protrusion operation is performed is excluded, or is subject to calculation processing of lowering its priority. That is, the ejector torque after a certain time has elapsed since the drive of the ejector mechanism 11 is started is adopted.

In addition, in the time period t3, the ejector pin 111 performs the accommodation operation while receiving assistance from the restoring force of the spring of the spring mechanism. Since the restoring force of the spring is a fourth element that is generated regardless of the deposition of the mold deposit, the restoring force of the spring is excluded in the processing of estimating the amount of deposition of the mold deposit, or is subject to calculation processing of lowering its priority. Therefore, for example, in the processing of estimating the amount of deposition of the mold deposit, the entire ejector torque in the time period t3 when the first accommodation operation is performed is excluded, or is subject to calculation processing of lowering its priority.

In addition, in the time period t4, the ejector pin 111 performs the second protrusion operation. However, since the molding product 200 is already released from the movable-side mold 52 and falls during the first protrusion operation, a collision resistance as in the first protrusion operation does not occur. Therefore, in the processing of estimating the amount of deposition of the mold deposit, the ejector torque in the time period t4 when the second protrusion operation is performed is adopted.

In addition, in the time period t2, when the ejector pin 111 starts the first protrusion operation, since the motor drives the ejector pin 111, noise is generated. Furthermore, even when the ejector pin 111 starts the second protrusion operation, since the motor drives the ejector pin 111, noise is generated. Since these noises are third elements that are generated regardless of the deposition of the mold deposit, the noises are excluded in the processing of estimating the amount of deposition of the mold deposit, or are subject to calculation processing of lowering their priority. Therefore, for example, in the processing of estimating the amount of deposition of the mold deposit, the entire ejector torque in the time period t2 when the first protrusion operation is performed is excluded, or is subject to calculation processing of lowering its priority. Furthermore, the third element of the ejector torque in the time period t4 when the second protrusion operation is performed is excluded, or is subject to calculation processing of lowering its priority.

In addition, in the time period t2, when the ejector pin 111 performs the first protrusion operation, the ejector pin 111 protrudes while the spring of the spring mechanism is contracted. Therefore, a restoring force of the spring of the spring mechanism is generated. In addition, in the time period t4, when the ejector pin 111 performs the second protrusion operation, the ejector pin 111 protrudes while the spring of the spring mechanism is contracted. Therefore, a restoring force of the spring of the spring mechanism is generated. Since the restoring force of these springs is a fourth element that is generated regardless of the deposition of the mold deposit, the restoring force of these springs is excluded in the processing of estimating the amount of deposition of the mold deposit, or is subject to calculation processing of lowering its priority. Therefore, for example, in the processing of estimating the amount of deposition of the mold deposit, the entire ejector torque in the time period t2 when the first protrusion operation is performed is excluded, or is subject to calculation processing of lowering its priority. Furthermore, the fourth element of the ejector torque in the time period t4 when the second protrusion operation is performed is excluded, or is subject to the calculation processing of lowering its priority.

In addition, in the time period t5, the ejector pin 111 performs the accommodation operation while receiving assistance from the restoring force of the spring of the spring mechanism. Since the restoring force of the spring is a fourth element that is generated regardless of the deposition of the mold deposit, the restoring force of the spring is excluded in the processing of estimating the amount of deposition of the mold deposit, or is subject to calculation processing of lowering its priority. Therefore, for example, in the processing of estimating the amount of deposition of the mold deposit, the entire ejector torque in the time period t5 when the second accommodation operation is performed is excluded, or is subject to the calculation processing of lowering its priority.

In the graph illustrated in FIG. 5, a time period t11 is a time period before the first protrusion operation is performed by the ejector pin 111. In the time period t11, since the ejector pin 111 is not driven, the ejector torque is substantially constant before and after the mold deposit is deposited on the mold 50, and both of the ejector torques illustrate the same value (substantially zero).

A time period t12 is a time period when the first protrusion operation is performed by the ejector pin 111. In the time period t12, since the ejector pin 111 is driven to perform the protrusion operation, the ejector torque is larger than that in the time period t11 either before or after the mold deposit is deposited on the mold 50. However, when the state before the mold deposit is deposited on the mold 50 (line L1) and the state after the mold deposit is deposited on the mold 50 (line L2) are compared, the following can be said. That is, the ejector torque after the mold deposit is deposited on the mold 50 is larger than the ejector torque before the mold deposit is deposited on the mold 50. That is, it can be seen that the amount of deposition of the mold deposit deposited on the mold 50 and the magnitude of the ejector torque are in a proportional relationship.

A time period t13 is a time period of waiting before the first accommodation operation is performed by the ejector pin 111. In the time period t13, since the ejector pin 111 waits while resisting the restoring force of the spring of the spring mechanism, the ejector torque is larger than that in the time period t11, and a substantially constant state is maintained. It is not necessary for the ejector pin 111 to wait before performing the accommodation operation, and may not wait as in the example of the graph of FIG. 4 described above.

A time period t14 is a time period when the first accommodation operation is performed by the ejector pin 111. In the time period t14, the ejector pin 111 performs an accommodation operation using the restoring force of the spring of the spring mechanism. Therefore, the absolute value of the ejector torque in the time period t14 in which the restoring force of the spring assists the accommodation operation is smaller than the absolute value of the ejector torque in the time period t12 in which the restoring force of the spring is the resistance of the protrusion operation. In addition, in the time period t14, the restoring force of the spring of the spring mechanism assists the accommodation operation of the ejector pin 111. Therefore, the difference between the ejector torque (line L1) before the mold deposit is deposited on the mold 50 and the ejector torque (line L2) after the mold deposit is deposited on the mold 50 is smaller than that in the time period t12.

A time period t15 is a time period when the second protrusion operation is performed by the ejector pin 111. In the time period t15, since the ejector pin 111 is driven to perform the protrusion operation, the ejector torque is larger than that in the time period t11 either before or after the mold deposit is deposited on the mold 50. However, when comparing before and after the mold deposit is deposited on the mold 50, the ejector torque (line L2) after the mold deposit is deposited on the mold 50 is larger than the ejector torque (line L1) before the mold deposit is deposited on the mold 50.

From the graph of FIG. 5, the following can be said about the difference between the ejector torque before the mold deposit is deposited on the mold 50 and the ejector torque after the mold deposit is deposited on the mold 50. That is, the difference at the time period t12 when the first protrusion operation is performed and the difference at the time period t15 when the second protrusion operation is performed are different from each other. This is because the ejector torque during the first protrusion operation includes the collision resistance (second element) generated between the ejector pin 111 and the molding product 200, but the ejector torque during the second protrusion operation does not include the collision resistance.

A time period t16 is a time period of waiting before the second accommodation operation is performed by the ejector pin 111. In the time period t16, since the ejector pin 111 waits while resisting the restoring force of the spring of the spring mechanism, the ejector torque is larger than that in the time period t11, and a substantially constant state is maintained.

A time period t17 is a time period when the second accommodation operation is performed by the ejector pin 111. In the time period t17, the ejector pin 111 performs an accommodation operation using the restoring force of the spring of the spring mechanism. Therefore, the absolute value of the ejector torque in the time period t17 in which the restoring force of the spring assists the accommodation operation is smaller than the absolute value of the ejector torque in the time period t15 in which the restoring force of the spring is the resistance of the protrusion operation. In addition, in the time period t17, the restoring force of the spring of the spring mechanism assists the accommodation operation of the ejector pin 111. Therefore, the difference between the ejector torque (line L1) before the mold deposit is deposited on the mold 50 and the ejector torque (line L2) after the mold deposit is deposited on the mold 50 is smaller than that in the time period t12 or the time period t15.

In addition, when the time period t14 during which the first accommodation operation is performed by the ejector pin 111 and the time period t17 during which the second accommodation operation is performed are compared, there is substantially no difference in the magnitude of the ejector torque.

A time period t18 is a time period after the second accommodation operation is performed by the ejector pin 111. In the time period t18, since the ejector pin 111 is not driven, the ejector torque returns to the level in the time period t1 and is substantially constant (substantially zero).

The graph illustrated in FIG. 5 includes the four elements (first to fourth elements) described above. However, since the second to fourth elements among the four elements are generated regardless of the deposition of the mold deposit, the second to fourth elements are excluded, or calculation processing of lowering their priority is performed. For example, in the time period t12, since the ejector pin 111 performs the first protrusion operation, the ejector pin 111 collides with the molding product 200, and a collision resistance occurs between the ejector pin 111 and the molding product 200. This collision resistance is a second element that is generated regardless of the deposition of the mold deposit. Therefore, in the processing of estimating the amount of deposition of the mold deposit, the ejector torque in the time period t12 is excluded, or calculation processing of lowering its priority is performed.

In addition, in the time period t15, the ejector pin 111 performs the second protrusion operation. However, since the molding product 200 is already released from the movable-side mold 52 and falls during the first protrusion operation, a collision resistance as in the first protrusion operation does not occur. Therefore, in the processing of estimating the amount of deposition of the mold deposit, the ejector torque in the time period t15 is adopted.

In addition, in the time period t12, when the ejector pin 111 starts the first protrusion operation, since the motor drives the ejector pin 111, noise is generated. Furthermore, even when the ejector pin 111 starts the second protrusion operation, since the motor drives the ejector pin 111, noise is generated. Since these noises are third elements that are generated regardless of the deposition of the mold deposit, the noises are excluded in the processing of estimating the amount of deposition of the mold deposit, or are subject to calculation processing of lowering their priority.

In addition, in the time period t12, when the ejector pin 111 performs the first protrusion operation, the ejector pin 111 protrudes while the spring of the spring mechanism is contracted. Therefore, a restoring force of the spring of the spring mechanism is generated. In addition, in the time period t15, when the ejector pin 111 performs the second protrusion operation, the ejector pin 111 protrudes while the spring of the spring mechanism is contracted. Therefore, a restoring force of the spring of the spring mechanism is generated. Since the restoring force of these springs is a fourth element that is generated regardless of the deposition of the mold deposit, the restoring force of these springs is excluded in the processing of estimating the amount of deposition of the mold deposit, or is subject to calculation processing of lowering its priority.

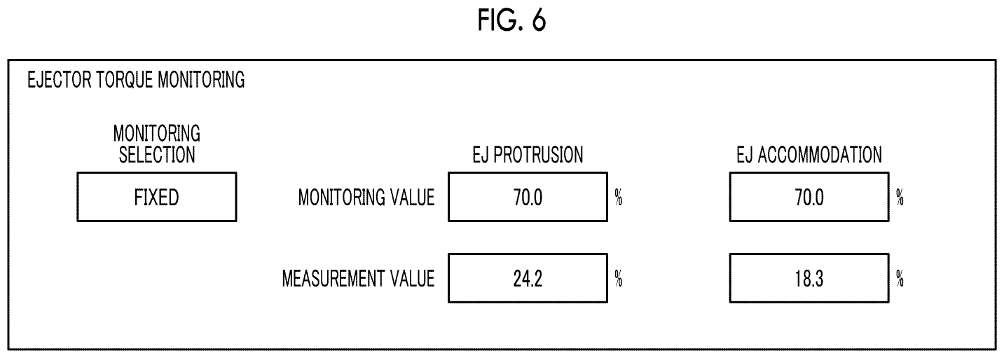

FIG. 6 is a diagram illustrating a specific example of information displayed on the display of the display unit 26 of FIG. 2.

As illustrated in FIG. 6, a screen marked “ejector torque monitoring” is displayed on the display of the display unit 26 of the injection molding machine 1. On the screen illustrated in FIG. 6, as information that assists a worker in determining the maintenance timing of the mold 50, each of the “monitoring value” and the “measurement value” in each of “EJ protrusion” and “EJ accommodation” is displayed. The “EJ protrusion” means a case where the protrusion operation of the ejector pin 111 is performed. In addition, “EJ accommodation” means that the accommodation operation of the ejector pin 111 is performed.

On the screen illustrated in FIG. 6, the “monitoring value” of “EJ protrusion” is “70.0” (%). This indicates that the maintenance timing of the mold 50 is detected when the measurement value of the current flowing through the motor that is driven to perform the protrusion operation of the ejector pin 111 exceeds 70% of the maximum value. In addition, the “monitoring value” of “EJ accommodation” is “70.0” (%). This indicates that the maintenance timing of the mold 50 is detected when the measurement value of the current flowing through the motor that is driven to perform the accommodation operation of the ejector pin 111 exceeds 70% of the maximum value.

In addition, on the screen illustrated in FIG. 6, the “measurement value” of “EJ protrusion” is “24.2” (%). This indicates that the measurement value of the ejector torque when the protrusion operation of the ejector pin 111 is performed, that is, the measurement value of the current flowing through the motor that is driven to perform the protrusion operation of the ejector pin 111, is “24.2” (%) of the maximum value. In addition, the “measurement value” of “EJ accommodation” is “18.3” (%). This indicates that the measurement value of the ejector torque when the accommodation operation of the ejector pin 111 is performed, that is, the measurement value of the current flowing through the motor that is driven to perform the accommodation operation of the ejector pin 111, is “18.3” (%) of the maximum value.

That is, in the example of the screen of FIG. 6, since the “measurement values” of both the “EJ protrusion” and the “EJ accommodation” do not reach the “monitoring value”, the maintenance timing of the mold 50 is not detected. On the other hand, in a case where any one of the “measurement values” of “EJ protrusion” and “EJ accommodation” reaches the “monitoring value”, the maintenance timing of the mold 50 is detected. In this case, an alert is output from the injection molding machine 1 to notify that the maintenance timing of the mold 50 is detected.

In addition, the screen illustrated in FIG. 6 illustrates that the “monitoring selection” is “fixed”. This indicates that the “monitoring value” is fixed. That is, it is indicated that the “monitoring value” is fixed to “70.0” (%) in both the “EJ protrusion” and the “EJ accommodation”. In addition to “fixed” illustrated in FIG. 6, “automatic” can be selected in the “monitoring selection”. In a case where the “monitoring selection” is “automatic”, the “monitoring value” is changed according to the past measurement results of the ejector torque. A case where the “monitoring value” is changed according to the past measurement result of the ejector torque will be described in a modification example to be described later.

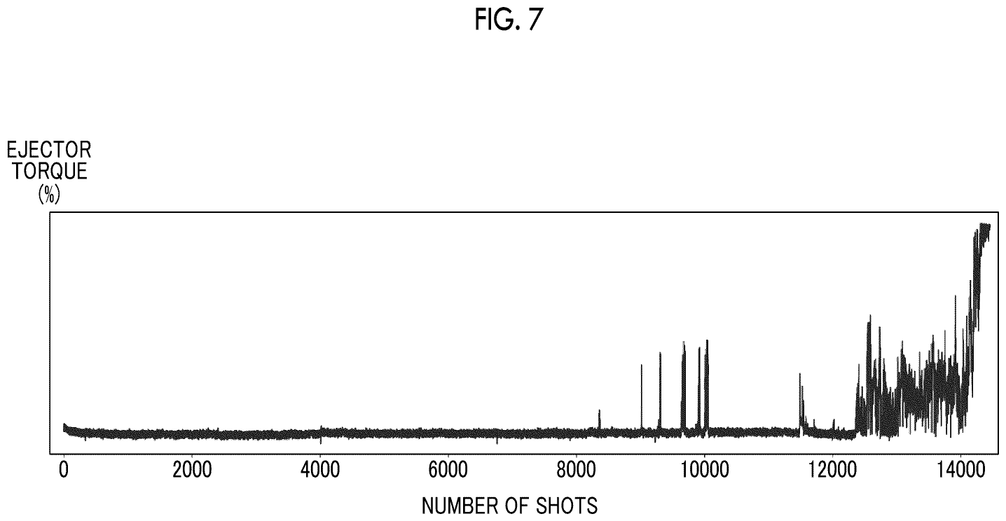

FIG. 7 is a diagram illustrating a specific example of a graph representing a relationship between the number of shots and the ejector torque.

The “number of shots” is the number of times the mold clamping unit 10 of the injection molding machine 1 performs a mold opening and closing operation. Therefore, the number of shots and the number of times the ejector mechanism 11 is driven are in a proportional relationship. In the example of FIG. 7, the ejector torque up to the number of shots “12000” may suddenly increase, but is basically stable at a constant magnitude. However, the ejector torque starts to increase when the number of shots exceeds “12000” and rapidly increases when the number of shots exceeds “14000”. This is because the mold deposit is deposited on the mold 50, and thus the frictional resistance (first element) generated between the ejector pin 111 and the mold 50 is increased.

Depending on the specification and the molding conditions of the injection molding machine 1, the mold deposit is normally deposited on the mold 50 as illustrated in FIG. 7, and it is necessary to monitor the value of the ejector torque having the number of shots of approximately 12000 until the change in the value of the ejector torque becomes noticeable. That is, it is necessary to store and be able to refer to the actual value of the ejector torque corresponding to the number of shots exceeding 12000, but the function of a normal injection molding machine does not store such a large amount of data. Therefore, the injection molding machine 1 according to the present embodiment causes the management unit 212 (refer to FIG. 3) to store and manage the actual value of the ejector torque in a storage server (not illustrated) existing on the network 90.

### Modification Example

The ejector mechanism 11 according to the present embodiment includes the spring mechanism that assists the accommodation operation of the ejector pin 111 as described above. However, the spring mechanism is not essential in the ejector mechanism 11. In a case of the ejector mechanism 11 that does not include the spring mechanism, the ejector pin 111 performs an accommodation operation without receiving assistance from the restoring force of the spring of the spring mechanism. Therefore, the ejector torque of the accommodation operation of the ejector pin 111 is adopted as it is.

In addition, in the present embodiment, as illustrated in the specific example of the screen of FIG. 6 described above, the “monitoring value” which is the threshold for determining the maintenance timing of the mold 50 is fixed, but the “monitoring value” may automatically change. For example, in a case where there is a tendency that the ejector torque gradually increases in the past measurement results of the ejector torque, the “monitoring value” may be changed to gradually increase in accordance with the tendency. That is, when the number of times the ejector pin 111 is driven increases, since the ejector torque naturally increases, the “monitoring value” may be changed in accordance with the monitoring purpose. As a result, for example, it is possible to perform monitoring with the main purpose of detecting a sudden increase in the ejector torque.

In addition, in the present embodiment, the first element is obtained by excluding the second to fourth elements from the measurement value of the acquired ejector torque, or performing calculation processing of lowering their priority. However, the present invention is not limited thereto. For example, only the first element may be acquired in a step of acquiring the ejector torque. In addition, for example, it may be clear that the protrusion operation and the accommodation operation of the ejector pin 111, which are performed after the molding product 200 is released from the movable-side mold 52, are an n-th (n is an integer value of 2 or more) protrusion operation and accommodation operation during which the mold opening and closing operation is performed once. In this case, the ejector torque of the n-th and subsequent protrusion operations and accommodation operations may be acquired.

In summary, the injection molding machine 1 according to the present embodiment only needs to have the following configuration, and can take various embodiments.

That is, the injection molding machine 1 includes the acquisition unit 211 that acquires, during the mold opening operation of the mold 50, at least one of the first measurement value (ejector torque) relating to the resistance when the protrusion operation of the ejector pin 111 to release the molding product 200 from the mold 50 in the mold-opened state is performed and the second measurement value (ejector torque) relating to the resistance when the accommodation operation of the ejector pin 111 is performed, and the estimation unit 214 that estimates the amount of deposition of the mold deposit deposited on the mold 50, based on at least one of the first measurement value excluding the element before the molding product 200 is released or lowering the priority of the element before the molding product 200 is released and the second measurement value.

As a result, the element before the molding product 200 generated regardless of the deposition of the mold deposit is released is excluded from the first measurement value and the second measurement value, or is subject to calculation processing of lowering its priority. As a result, it is possible to estimate the amount of deposition of the mold deposit based on only the frictional resistance generated between the ejector pin 111 and the mold 50.

Here, the injection molding machine may further include the spring mechanism that generates the force in a direction in which the accommodation operation of the ejector pin 111 is performed (mold opening and closing direction), in which the estimation unit 214 may estimate the amount of deposition of the mold deposit deposited on the mold 50 by excluding the second measurement value or lowering the priority of the second element in a case where the first measurement value and the second measurement value are acquired.

As a result, it is possible to estimate the amount of deposition of the mold deposit in consideration of a decrease in sensitivity due to the restoring force of the spring of the spring mechanism assisting the accommodation operation of the ejector pin 111.

In addition, the injection molding machine may further include the detection unit 215 that detects the maintenance timing of the mold 50, based on the estimated amount of deposition.

As a result, the maintenance timing of the mold 50 can be accurately determined.

In addition, the estimation unit 214 may estimate the amount of deposition of the mold deposit deposited on the mold 50, based on the magnitude of the frictional resistance generated between the ejector pin 111 and the mold 50, the frictional resistance being obtained from the acquired first measurement value by excluding, as the elements before the molding product 200 is released, the collision resistance generated between the ejector pin 111 and the molding product 200 and the noise of the motor that drives the ejector pin 111, or lowering their priority.

As a result, the collision resistance generated between the ejector pin 111 and the molding product 200 and the noise of the motor that drives the ejector pin 111 are excluded as the elements before the molding product 200 is released, regardless of the deposition of the mold deposit. Alternatively, calculation processing of lowering their priority is performed. As a result, it is possible to estimate the amount of deposition of the mold deposit based on the frictional resistance generated between the ejector pin 111 and the mold 50.

In addition, the injection molding machine may further include the management unit 212 that stores and manages the acquired first measurement value and second measurement value in an external storage medium.

As a result, even in a case where the injection molding machine 1 does not have a sufficient storage area in which data of the first measurement value and the second measurement value can be stored, it is possible to estimate the amount of deposition of the mold deposit based on the first measurement value and the second measurement value by accessing the external storage medium.

In addition, the method of estimating the amount of deposition of the mold deposit according to the present embodiment only needs to have the following configuration, and can take various embodiments.

That is, the method of estimating the amount of deposition of the mold deposit includes a step of acquiring, during the mold opening operation of the mold 50, at least one of the first measurement value (ejector torque) relating to the resistance when the protrusion operation of the ejector pin 111 to release the molding product 200 from the mold 50 in the mold-opened state is performed and the second measurement value (ejector torque) relating to the resistance when the accommodation operation of the ejector pin 111 is performed, and a step of estimating the amount of deposition of the mold deposit deposited on the mold 50, based on the first measurement value excluding the element before the molding product 200 is released or lowering the priority of the element before the molding product 200 is released.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
an acquisition unit configured to acquire, during a mold opening operation of a mold, at least one of a first measurement value relating to a resistance when a protrusion operation of an ejector pin to release a molding product from the mold in a mold-opened state is performed and a second measurement value relating to a resistance when an accommodation operation of the ejector pin is performed; and
an estimation unit configured to estimate an amount of deposition of a mold deposit deposited on the mold, based on at least one of the first measurement value, excluding an element before the molding product is released or lowering a priority of the element, and the second measurement value.

2. The injection molding machine according to claim 1, further comprising:
a spring mechanism that generates a force in a direction in which the accommodation operation of the ejector pin is performed, wherein
the estimation unit estimates the amount of deposition by excluding the second measurement value or lowering a priority of the second measurement value in a case where the first measurement value and the second measurement value are acquired.

3. The injection molding machine according to claim 1, further comprising:
a detection unit configured to detect a maintenance timing of the mold, based on the amount of deposition that is estimated.

4. The injection molding machine according to claim 1, wherein
the estimation unit estimates an amount of deposition of a mold deposit deposited on the mold, based on a magnitude of a frictional resistance generated between the ejector pin and the mold, the frictional resistance being obtained from the first measurement value that is acquired, by excluding, as the element and an additional element, a collision resistance generated between the ejector pin and the molding product and a noise of a motor that drives the ejector pin, or lowering a priority of the elements.

5. The injection molding machine according to claim 1, further comprising:
a management unit configured to store and manage the first measurement value and the second measurement value, which are acquired, in an external storage medium.

6. The injection molding machine according to claim 5, wherein
the management unit manages information required to estimate the amount of deposition of the mold deposit deposited on the mold.

7. The injection molding machine according to claim 6, wherein
the management unit stores and manages, through connection to a network, past actual values of the first measurement value and the second measurement value in a storage server existing on the network.

8. The injection molding machine according to claim 5, further comprising:
a generation unit configured to generate information for estimating the amount of deposition based on actual values of the first measurement value and the second measurement value that are managed by the management unit.

9. The injection molding machine according to claim 8, wherein
the generation unit generates a graph representing time changes of the first measurement value measured during the protrusion operation of the ejector pin and the second measurement value measured during the accommodation operation of the ejector pin.

10. The injection molding machine according to claim 3, further comprising:
an output unit configured to output information for notifying of the maintenance timing of the mold detected by the detection unit.

11. A method of estimating an amount of deposition of a mold deposit, the method comprising:
a step of acquiring, during a mold opening operation of a mold, at least one of a first measurement value relating to a resistance when a protrusion operation of an ejector pin to release a molding product from the mold in a mold-opened state is performed and a second measurement value relating to a resistance when an accommodation operation of the ejector pin is performed; and
a step of estimating an amount of deposition of a mold deposit deposited on the mold, based on at least one of the first measurement value, excluding an element before the molding product is released or lowering a priority of the element, and the second measurement value.
